(19) United States
(12) Patent Application Publication
(10) Pub. No.: US 2008/0148370 A1
(43) Pub. Date: Jun. 19, 2008

(54) Method and multi-function machine having an email system for password protecting scanned documents

(75) Inventor: Julia Allwright, London (GB)

Correspondence Address: Xerox Corporation (CDFS), 445 Broad Hollow Rd.-Suite 225, Melville, NY, 11747, US

(73) Assignee: Xerox Corporation

(21) Appl. No.: 11/641,630

(22) Filed: Dec. 19, 2006

(51) Int. Cl. H04L 9/32

(52) U.S. Cl. 726/5

(57) ABSTRACT

A method and a multi-function machine having an email system are provided for enabling password protection of electronic image files produced using the scan-to-file and scan-to-email functions of the multi-function machine. The email system and method enable a user to compose a message and to attach one or more attachments to accompany the message using an email editor of the email system. The email system and method provide a password protect option for enabling the sender of the one or more electronic image file attachments to password protect these attachments prior to transmission using the email system. If an electronic image file attachment is password protected, then a recipient of the electronic image file is prompted to enter the password corresponding to the electronic image file prior to being permitted to open and view the file.

### BACKGROUND

The present disclosure relates to multi-function machines, and more particularly, to a method and a multi-function machine having an electronic mail (email) system for password protecting scanned documents attached to a composed email message.

Electronic mail systems or editors, such as Microsoft® Outlook, include a graphical user interface for allowing one to compose and send email messages to individuals identified by corresponding email addresses and groups of individuals identified by an alias or distribution list (name string). An alias or distribution list identifies a group of individuals who are frequently contacted by the sender in order to facilitate identification and/or reduce the burden of repeatedly entering the individual email addresses. As it is well known, a sender can address a single message to many recipients by separating the email addresses of the recipients and/or one or more aliases identifying groups of individuals with a semicolon or comma in a header of the graphical user interface of the email editor.

Prior to transmission of the email message, it is commonly known that the sender can attach one or more documents to the email message. The documents can be electronic image files of scanned documents in a TIFF, multi-page TIFF, JPG, PDF or other formats. The documents can be scanned and saved in these formats using “multi-function” machines which have become familiar in offices.

Whereas, previously, functions such as copying, printing, and facsimile transmission have been performed by single dedicated copiers, printers, and facsimiles respectively, a multi-function machine is typically capable of providing all such functions and more in a single machine. Typically such a multi-function machine includes a single print engine, which can serve to output copies, prints, or received facsimiles; as well as a single input scanner which can serve to record data from original images for use in copying, facsimile transmission, and retention of input image data to a predetermined location in a computer memory (“scan-to-file”).

Such multi-function machines are typically connected to data networks, such as the Internet, for exchange of both image data and associated operational instructions. Their connection to data networks also enables a user to scan a document to create an electronic image file and email the electronic image file using a scan-to-email function typically found on such multi-function machines. The scan-to-email function can also be used to email a previously stored electronic image file using the scan-to-file function. The multi-function machine can be a xerographic machine which uses xerographic printing techniques to print a reproduction of a document placed on a platen glass. Exemplary xerographic multi-function machines are the Xerox WorkCentre™ PE120 and Pro65 models available from the XEROX Corporation.

The scan-to-email function generally enables the user to use a personal computer connected to the multi-function machine via a data network or a computer incorporated with the multi-function machine to execute an email editor, access the electronic image file from a memory of the multi-function machine and import it to the email editor for transmitting it as an attachment to an email message composed using the email editor. The message and the attachment are transmitted to one or more recipients whose email address is provided in the header of the graphical user interface of the email editor and all individuals associated with the one or more aliases also provided in the header after selecting a “Send” icon. Once the email with the accompanying electronic image file attachments are received by the recipients, the email message and the attachments can be viewed.

Conventional scan-to-file and scan-to-email functions do not provide the capability to secure the electronic image files which are produced by scanning documents using a multi-function machine from unintended recipients and other individuals.

### SUMMARY

It is an aspect of the present disclosure to provide a method and a multi-function machine having an email system for enabling the securing of electronic images files produced using the scan-to-file and scan-to-email functions of a multi-function machine. According to the present disclosure, a method and a multi-function machine having an email system are provided for enabling password protection of electronic image files produced using the scan-to-file and scan-to-email functions of the multi-function machine. The email system and method enable a user to compose a message and to attach one or more attachments to accompany the message using an email editor of the email system.

Additionally, in accordance with the present disclosure, the email system and method provide a password protect option for enabling the sender of the one or more electronic image file attachments to password protect these attachments prior to transmission using the email system. If an electronic image file attachment is password protected, then a recipient of the electronic image file is prompted to enter the password corresponding to the electronic image file prior to being permitted to open and view the file.

The email system includes an email software program which includes several modules each having a set of programmable instructions. The multi-function machine includes at least one processor for executing each set of programmable instructions for performing the functions of each module in accordance with the present disclosure.

The email software program can be packaged and distributed as an email software package for downloading to the multi-function machine where the set of programmable instructions of each module are stored within at least one computer-readable medium, such as a CD-ROM, diskette, etc. The email software program can also be downloaded to the multi-function machine through a network connection connecting the multi-function machine to a remote computer station storing the modules of the email software program.

One module of the email software program is an email creation module or email editor module configured to enable one to compose an email message in a body segment displayed by the email creation module for transmission to at least one recipient whose email address is provided in a header segment displayed by the email creation module. The email creation module also enables a user to attach one or more image-file attachments to accompany the composed email message, such as an image-file created by scanning one or more documents using a scan-to-file or scan-to-email function provided by a multi-function machine. The image-file can be saved in one of a plurality of formats, such as TIFF, multi-page TIFF, JPG, PDF or other formats.

Another module of the email software program is a password protect module configured to provide the option of enabling one to password protect the one or more image-file attachments. If the user opts to password protect an image-file attachment by selecting a particular icon displayed by the email system, the password protect module displays a window requesting the user to enter a password. After entering the password, the user selects an “OK” icon and the password protect module password protects the image-file attachment using the entered password. Upon receipt of the email message and accompanying image-file attachments, the password protect module executed by a processor of the recipient's computer system, prompts the recipient of the email message to enter the password to open and view the image-file attachment when the recipient attempts to open the image-file attachment.

If there is more than one image-file attachment, the password protect module uses the same password to password protect all of the image-file attachments. It is contemplated, however, that the password protect module can be configured for enabling the user to enter a different password for each of the image-file attachments. As such, if there is more than one recipient, the user can select different passwords for each of the image-file attachments and selectively provide the passwords to the recipients for enabling one recipient to open and view a select group of image-file attachments and enabling another recipient to open and view another select group of image-file attachments, where the two select groups of image-file attachments may consist of different image-file attachments, or at least one identical image-file attachment.

As an added security measure, the password protect module includes an encryption/decryption module configured to encrypt the image-file attachments upon the attachments being password protected. Hence, the password acts as a security key which prompts the encryption/decryption module of the password protect module to encrypt the image-file attachments when the sender enters the password. The encryption/decryption module encrypts the image-file attachments using conventional image-file encryption techniques and methodologies, such as PGP® encryption. The password also prompts the encryption/decryption module to decrypt the encrypted image-file attachments when the recipient enters the password.

One additional module of the email software program is a transmission module configured to transmit the composed email message and image-file attachments to at least one email address corresponding to the recipient.

In particular, the present disclosure provides a multi-function machine having at least one processor; and an email system. The email system includes an email creation module having a set of programmable instructions configured for execution by the at least one processor for composing an email message; and a password protection module having a set of programmable instructions configured for execution by the at least one processor for receiving a password and password protecting an image-filed attachment to accompany the composed email message during transmission thereof to an email address corresponding to a recipient. The email system further includes a transmission module having a set of programmable instructions configured for execution by the at least one processor for transmitting the composed email message and the image-file attachment to the email address corresponding to the recipient. The image-file attachment is created using a scanning feature of the multi-function machine, such as the scan-to-file or scan-to-email feature.

The method for password protecting an image-file attachment corresponding to a composed email message includes scanning a document using a scanning feature of a multi-function machine; attaching the scanned document as the image-file attachment to the composed email message in response to a user input; requesting entry of a password upon selection of a password protection icon displayed by a graphical user interface of an email software program executed by at least one processor of the multi-function machine; and password protecting the image-file attachment after receiving the password. The method further includes requesting a recipient of the composed email message and the image-file attachment to enter the password for opening and viewing the image-file attachment. The step of password protecting the image-file attachment includes the encrypting the image-file attachment after receiving the password.

The present disclosure also provides a computer-readable medium storing a set of programmable instructions configured for being executed by at least one processor for performing a method of password protecting an image-file attachment corresponding to a composed email message. The method includes scanning a document using a scanning feature of a multi-function machine; attaching the scanned document as the image-file attachment to the composed email message in response to a user input; requesting entry of a password upon selection of a password protection icon displayed by a graphical user interface of an email software program executed by at least one processor of the multi-function machine; and password protecting the image-file attachment after receiving the password. The method further includes requesting a recipient of the composed email message and the image-file attachment to enter the password for opening and viewing the image-file attachment. The step of password protecting the image-file attachment includes encrypting the image-file attachment after receiving the password.

### BRIEF DESCRIPTION OF THE DRAWINGS

Various embodiments of the present disclosure will be described herein below with reference to the figures wherein:

FIG. 1 is a block diagram of a system for password protecting an image-file attachment to an email message in accordance with the present disclosure;

FIG. 2 is a flow chart illustrating a method for password protecting an image-file attachment to an email message in accordance with the present disclosure;

FIG. 3 illustrates an exemplary email screen having a password protect icon or button for password protecting an image-file attachment to accompany an email message in accordance with the present disclosure;

FIG. 4A illustrates a window instructing a sender of an email message to enter a password to password protect an image-file attachment to accompany the email message in accordance with the present disclosure; and

FIG. 4B illustrates a window instructing a recipient of an email message to enter a password to open an image-file attachment accompanying the email message in accordance with the present disclosure.

### DETAILED DESCRIPTION

The present disclosure provides a method and a multi-function machine having an email system for password protecting an electronic image-file attachment to accompany an email message composed using an email system or editor, such as, for example, Microsoft® Outlook. The email system and method further enable transmission of the email message to at least one recipient who is instructed to enter a password to open and view the image-file attachment.

In particular, the present disclosure provides a method and a multi-function machine having an email system for password protecting electronic image files produced using the scan-to-file and scan-to-email functions of the multi-function machine. The email system and method enable a user to compose an email message and to attach one or more attachments to accompany the email message using an email editor of the email system. The one or more attachments are electronic image files produced using the scan-to-file and scan-to-email functions provided on a host of multi-function machines.

The email system and method provide a password protect option for enabling the sender of the one or more electronic image file attachments to password protect these attachments prior to transmission using the email system. If an electronic image file attachment is password protected, then a recipient of the electronic image file is prompted to enter the password corresponding to the electronic image file prior to being permitted to open and view the file.

As further described below with reference to the figures, the email system includes an email software program which includes several modules each having a set of programmable instructions. The multi-function machine includes at least one processor for executing each set of programmable instructions for performing the functions of each module in accordance with the present disclosure.

The email software program can be packaged and distributed as an email software package for downloading to the multi-function machine where the set of programmable instructions of each module are stored within at least one computer-readable medium, such as a CD-ROM, flash memory device, diskette, etc. The email software program can also be downloaded to the multi-function machine through a network connection connecting the multi-function machine to a remote computer station, such as remote server 36, storing the modules of the email software program.

One module of the email software program is an email creation module or email editor module configured to enable one to compose an email message in a body segment displayed by the email creation module for transmission to at least one recipient whose email address is provided in a header segment displayed by the email creation module. The email creation module also enables a user to attach one or more image-file attachments to accompany the composed email message, such as an image-file created by scanning one or more documents using a scan-to-file or scan-to-email function provided by a multi-function machine. The image-file can be saved in one of a plurality of formats, such as TIFF, multi-page TIFF, JPG, PDF or other formats.

Another module of the email software program is a password protect module configured to provide the option of enabling one to password protect the one or more image-file attachments. If the user opts to password protect an image-file attachment by selecting a particular icon displayed by the email system, the password protect module displays a window requesting the user to enter a password. After entering the password, the user selects an “OK” icon and the password protect module password protects the image-file attachment using the entered or received password. Upon receipt of the email message and accompanying image-file attachments, the password protect module executed by a processor of the recipient's computer system, prompts the recipient of the email message to enter the password to open and view the image-file attachment when the recipient attempts to open the image-file attachment.

If there is more than one image-file attachment, the password protect module uses the same password to password protect all of the image-file attachments. It is contemplated, however, that the password protect module can be configured for enabling the user to enter a different password for each of the image-file attachments. As such, if there is more than one recipient, the user can select different passwords for each of the image-file attachments and selectively provide the passwords to the recipients for enabling one recipient to open and view a select group of image-file attachments and enabling another recipient to open and view another select group of image-file attachments, where the two select groups of image-file attachments may consist of different image-file attachments, or at least one identical image-file attachment.

One additional module of the email software program is a transmission module configured to transmit the composed email message and image-file attachments to at least one email address corresponding to the recipient.

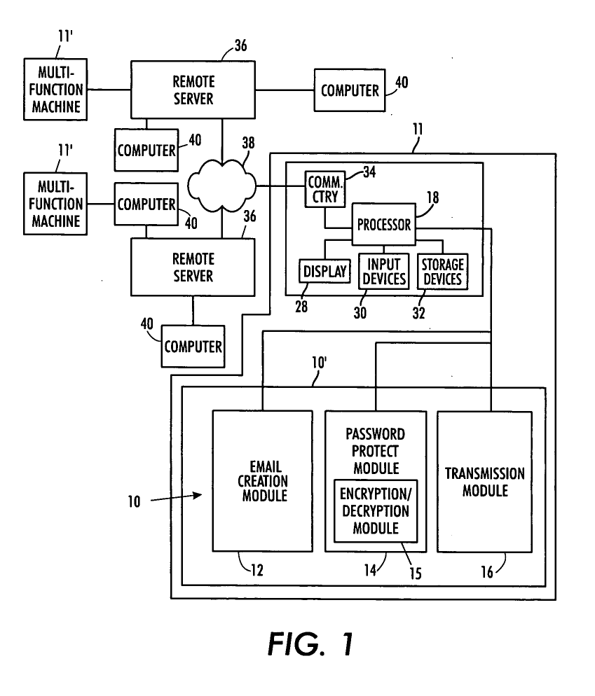

With reference to FIG. 1, there is shown a block diagram of a system for password protecting an email message in accordance with the present disclosure. The system includes a multi-function machine 11 having an email system designated generally by reference numeral 10. The email system 10 includes an email software program 10′ which includes several modules 12, 14, 15, 16.

Each module of the email software program 10′ includes a set of programmable instructions configured for execution by at least one processor 18 of the multi-function machine 11 for performing the functions in accordance with the present disclosure. The set of programmable instructions can be application software stored within a memory, such as RAM and ROM, of the at least one processor 18 and/or a computer-readable medium, such as a hard drive, CD-ROM, DVD, 3.5″ diskette, etc., readable by one or more reading devices of the multi-function machine 11.

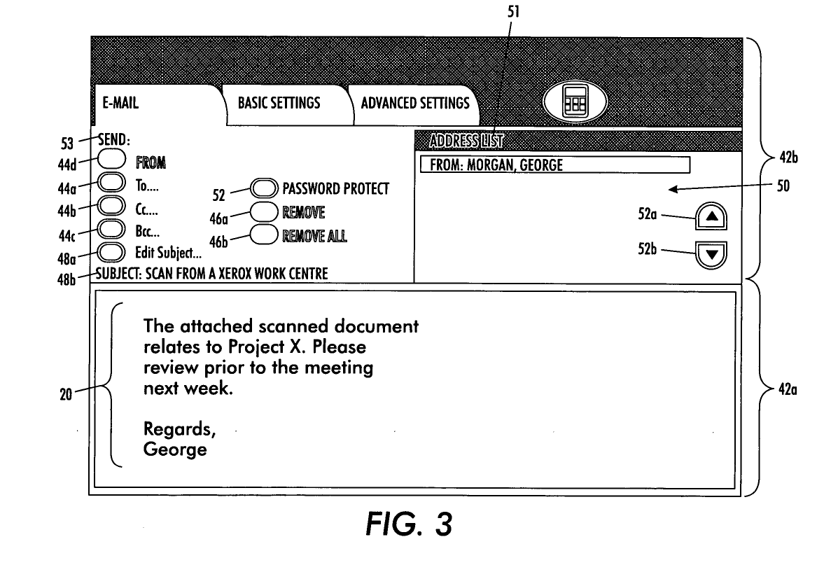

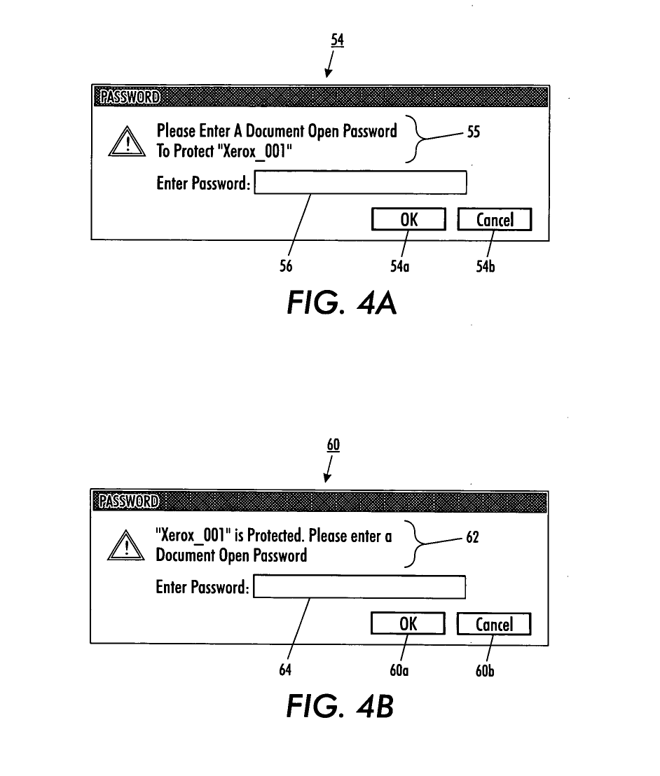

One module of the email software program 10′ is an email creation module or email editor module 12 configured to enable one to compose an email message 20 (see FIG. 3) for transmission to at least one remote server 36. Another module of the email software program 10′ is a password protect module 14 configured to enable the sender of the email message to password protect one or more image-file attachments to accompany the email message 20. When the recipient attempts to open and view the one or more image-file attachments, a window 60 (see FIG. 4B) is displayed by the password protect module 14 instructing the recipient to enter the password.

The password protect module 14 includes an encryption/decryption module 15 configured to encrypt the image-file attachments upon the attachments being password protected. Hence, the password acts as a security key which prompts the encryption/decryption module 15 of the password protect module 14 to encrypt the image-file attachments when the sender enters the password. The encryption/decryption module 15 encrypts the image-file attachments using conventional image-file encryption techniques and methodologies, such as PGP® encryption. The password also prompts the encryption/decryption module 15 to decrypt the encrypted image-file attachments when the recipient enters the password.

One additional module of the email software program 10′ is a transmission module 16 configured to transmit the composed email message and image-file attachments to at least one email address corresponding to the recipient.

The modules 12, 14, 15, 16 can also include additional programmable instructions capable of being executed by the at least one processor 18 for performing other functions which are known in the art for conventional email editors or email systems, such as storing contact information, storing sent and received email messages, searching email messages for particular keywords, adding attachments to composed email messages, etc. The email system 10 can also include additional modules for performing these and other functions.

The at least one processor 18 is in operable communication with a display device 28 for displaying various screens, including email-related screens in accordance with the present disclosure and as shown, for example, by FIGS. 3, 4A and 4B; one or more input devices 30, such as a keypad, control panel, and document scanner; one or more external storage devices 32, such as a database; and communication circuitry 34 for enabling the multi-function machine 11 to receive and transmit messages from and to one or more remote servers 36 via a communications network 38, such as the Internet. The one or more servers 36 are linked to a plurality of computers or terminals 40 as known in the art.

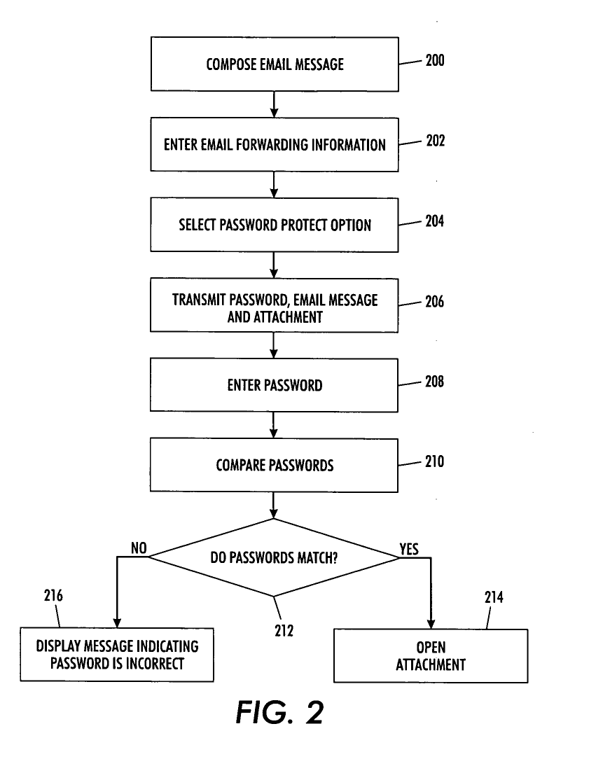

In operation, with reference to FIGS. 2 and 3, the email creation module or email editor module 12 of the email software program 10′ is used to compose the email message 20 in a body segment 42a displayed by the email creation module 12 (Step 200). It is contemplated that an email message 20 does not need to be created and the image-file attachments produced by the multi-function machine 11 can be transmitted to one or more recipients without an accompanying email message 20. The email message 20 can be composed by using the keypad of the multi-function machine 11 or a touch screen display of the multi-function machine 11 displaying a virtual keyboard.

The email creation module 12 is also used to enter email forwarding information, i.e., at least one email address; at least one email alias; or at least one email address and at least one email alias in a header segment 42b displayed by the email creation module 12 (Step 202). The email forwarding information is entered by selecting the “TO” icon 44a under the heading “Send” 53 and selecting at least one email address, at least one email alias, or at least one email address and at least one email alias from a drop down menu using arrow icons. Alternatively, the email forwarding information can be entered using a keypad of the multi-function machine 11 to type the email forwarding information or a touch screen display of the multi-function display 11 displaying a virtual keyboard. Similarly, the user can select the “CC” and “BCC” icons 44b, 44c under the heading “Send” 53 to enter additional email forwarding information. The heading “Address List” 51 can be selected for viewing the recipient email addresses and aliases.

The sender's email information, and not necessarily the email address corresponding to the multi-function machine 11, is entered by a keypad of the multi-function machine 11. Alternatively, the sender's email information can be entered using a drop down menu displayed in space 50 after icon “FROM” 44d under the heading “Send” 53 is selected. The sender's email information (i.e., email address) is entered and transmitted to the recipient for informing the recipient of the sender's email address, in case the recipient wants to respond directly to the sender's email address. However, it is provided that the recipient of the email upon receiving the email will notice that the email was transmitted from an email or other network address corresponding to the multi-function machine 11.

Other icons displayed by the header segment 42b include the “Remove” and “Remove All” icons 46a, 46b. These icons are used to remove one or all of the entered or selected email addresses or aliases. An “Edit Subject” icon 48a is used to edit a subject line 48b using a keypad of the multi-function machine 11.

In accordance with the present disclosure, the header segment 42b includes a “Password Protect” icon 52 for providing the sender with the option of password protecting at least one image-file attachment accompanying the composed email message 20 (Step 204). One or more file names corresponding to the attached image-file attachments can be displayed in the header segment 42b. In order to password protect an attached image-file attachment, the sender selects the “Password Protect” icon 52 and is provided with a window 54 as shown by FIG. 4A for entering a password. The window 54 includes a message 55 stating “Please Enter A Document Open Password To Protect ‘Xerox_{—}001’:” as shown by FIG. 4A.

After opening the window 54, if the sender decides not to password protect the image-file attachment, the sender can select the “Cancel” icon 54b to close the password protect window 54. If the sender after opening the window 54 still desires to password protect the image-file attachment, the sender enters a password in space 56 using a keypad of the multi-function machine 11 and selects the “OK” icon 54a. Upon selecting the “OK” icon 54a, the image-file attachment is password protected.

In order to be able to open the password protected image-file attachment at a later time, the multi-function machine 11 stores in memory the file name of the image-file attachment and the corresponding password. The password protect module 14 encrypts the password using the encryption/decryption module 15 prior to storing the password in memory. The encrypted password in an embodiment according to the present disclosure is transmitted with the composed email message 20 and password protected image-file attachment (Step 206) for decryption by a remote server 36, computer 40 or multi-function machine 11′ using another encryption/decryption module 15 after the sender authorizes the transmission of the email message 20 and password protected image-file attachment. The sender authorizes the transmission by pressing, for example, a “START” button on the multi-function machine 11 or selecting a “SEND” icon (not shown) which causes the execution of the transmission module 16 by the at least one processor 18. The decrypted password is used to determine whether the recipient entered the correct password in a window 60 displayed by a display of the recipient's computer 40 or multi-function machine 11′.

With reference to FIG. 4B, the window 60 includes a message 62 which states “‘Xerox_{—}001’ is Protected. Please enter a Document Open Password.” The recipient enters a password in space 64 and selects the “OK” icon 60a (Step 208). If the recipient decides not to enter the password, the recipient can select the “Cancel” icon 60b to close window 60.

After entering the password in space 64 and selecting the “OK” icon 60a, the password protect module 14 compares the entered password with the password entered by the sender and which corresponds to the image-file attachment the recipient desires to open and view (Step 210). The comparison is made by comparing the password entered by the recipient with the password entered by the sender and transmitted with the composed email message 20 in encrypted form, or by transmitting the password entered by the recipient to the multi-function machine 11 and comparing the recipient entered password with the password saved in memory of the multi-function machine 11.

In the former case, the encrypted password is decrypted by the encryption/decryption module 15 executed by a processor embedded within the remote server 36, the recipient's computer 40, or multi-function machine 11′. In the latter case, the comparison result is transmitted to the remote server 36, the recipient's computer 40, or multi-function machine 11′.

In either case, a determination is made as to whether the two passwords match (Step 212). If the two passwords match, the password protection module 14 opens the image-file attachment for enabling the recipient to view it (Step 214). If the two passwords do not match, the recipient is notified by a message displayed by the display of the recipient's computer 40 or multi-function machine 11′ that the password is incorrect (Step 216). The email software program can allow the recipient to try again by entering another password.

It is provided that if the two passwords match and the image-file attachment is encrypted, the encryption/decryption module 15 of the email software program executed by the processor embedded within the remote server 36, the recipient's computer 40 or multi-function machine 11 decrypts the image-file attachment. The multi-function machines 11, 11′ are xerographic multi-function machines.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A multi-function machine comprising:
at least one processor; and
an email system comprising:
an email creation module having a set of programmable instructions configured for execution by the at least one processor for composing an email message; and
a password protection module having a set of programmable instructions configured for execution by the at least one processor for receiving a password and password protecting an image-file attachment to accompany the composed email message during transmission thereof to an email address corresponding to a recipient, wherein the image-file attachment is created using a scanning feature of the multi-function machine.

2. The multi-function machine according to claim 1, further comprising a transmission module having a set of programmable instructions configured for execution by the at least one processor for transmitting the composed email message and the image-file attachment to the email address corresponding to the recipient.

3. The multi-function machine according to claim 2, wherein the email creation module, the password protection module and the transmission module are components of an email software program.

4. The multi-function machine according to claim 1, wherein the scanning feature is selected from the group consisting of scan-to-file and scan-to-email features.

5. The multi-function machine according to claim 1, further comprising an encryption/decryption module having a set of programmable instructions configured for execution by a processor, including the at least one processor, for encrypting and decrypting at least one of the password and the composed email message.

6. The multi-function machine according to claim 1, wherein execution by a processor, including the at least one processor, of the set of programmable instructions corresponding to the password protection module further compares a received password entered by the recipient of the composed email message with the received password and determines whether to open the password protected image-file attachment in accordance with the comparison.

7. The multi-function machine according to claim 1, wherein the multi-function machine is a xerographic multi-function machine.

8. A method for password protecting an image-file attachment corresponding to a composed email message, the method comprising:
scanning a document using a scanning feature of a multi-function machine;
attaching the scanned document as the image-file attachment to the composed email message in response to a user input;
requesting entry of a password upon selection of a password protection icon displayed by a graphical user interface of an email software program executed by at least one processor of the multi-function machine; and
password protecting the image-file attachment after receiving the password.

9. The method according to claim 8, further comprising transmitting the composed email message and the image-file attachment to an email address corresponding to a recipient.

10. The method according to claim 8, wherein the step of password protecting is performed by at least one processor of the multi-function machine executing a set of programmable instructions corresponding to a password protect module.

11. The method according to claim 8, wherein the scanning feature is selected from the group consisting of scan-to-file and scan-to-email features.

12. The method according to claim 8, further comprising encrypting and decrypting at least one of the password and the composed email message.

13. The method according to claim 8, further comprising requesting a recipient of the composed email message and the image-file attachment to enter a password.

14. The method according to claim 13, further comprising comparing the password entered by the recipient of the composed email message with the received password and determining whether to open the password protected image-file attachment in accordance with the comparison.

15. The method according to claim 8, wherein the multi-function machine is a xerographic multi-function machine.

16. A computer-readable medium storing a set of programmable instructions configured for being executed by at least one processor for performing a method of password protecting an image-file attachment corresponding to a composed email message, the method comprising:
scanning a document using a scanning feature of a multi-function machine;
attaching the scanned document as the image-file attachment to the composed email message in response to a user input;
requesting entry of a password upon selection of a password protection icon displayed by a graphical user interface of an email software program executed by at least one processor of the multi-function machine; and
password protecting the image-file attachment after receiving the password.

17. The computer-readable medium according to claim 16, wherein the method further comprises transmitting the composed email message and the image-file attachment to an email address corresponding to a recipient.

18. The computer-readable medium according to claim 16, wherein the scanning feature is selected from the group consisting of scan-to-file and scan-to-email features.

19. The computer-readable medium according to claim 16, wherein the method further comprises encrypting and decrypting at least one of the password and the composed email message.

20. The computer-readable medium according to claim 16, wherein the method further comprises requesting a recipient of the composed email message and the image-file attachment to enter a password.

21. The computer-readable medium according to claim 20, wherein the method further comprises comparing the password entered by the recipient of the composed email message with the received password and determining whether to open the password protected image-file attachment in accordance with the comparison.

22. The computer-readable medium according to claim 16, wherein the multi-function machine is a xerographic multi-function machine.
